(19) United States
(12) Patent Application Publication
(10) Pub. No.: US 2009/0112710 A1
(43) Pub. Date: Apr. 30, 2009

(54) METHODS AND APPARATUS FOR ADVERTISING

(76) Inventor: Jose Manuel Ballina, Guanajuato (MX)

Correspondence Address: PATTERSON & SHERIDAN, L.L.P., 3040 POST OAK BOULEVARD, SUITE 1500, HOUSTON, TX, 77056, US

(21) Appl. No.: 11/931,390

(22) Filed: Oct. 31, 2007

(51) Int. Cl. G09F 21/04; B62D 25/18; G06Q 30/00

(52) U.S. Cl. 705/14; 280/851; 40/587; 40/584

(57) ABSTRACT

A method and apparatus for advertisement using printed graphic images bonded to rubber based products, such as mud flaps for vehicles and tile for flooring.

### BACKGROUND OF THE INVENTION

1. Field of the Invention

Embodiments of the present invention generally relate to methods and apparatus for advertisement using printed graphic images bonded to rubber based products, such as mud flaps for vehicles and tile for flooring.

2. Description of the Related Art

Mud flaps are used to protect vehicles from objects and materials that are projected from car and truck tires. In certain instances, particular types of vehicles, such as large big rig trucks, are required by law to have mud flaps placed on them. Due to the traffic regulations, about 95% of the mud flaps sold in the USA have standard sizes.

A large amount of the raw materials used for manufacturing mud flaps come from scrap or tire friction generated by tire manufactures, including defective tires. Masticated tire friction material has excellent weather resistance properties and textile cords that reinforce the already good tear resistance of the rubber itself. However, a problem with rubber based mud flaps is that their attractiveness is limited but their visibility to large numbers of people is frequent.

To explain, templates can be used to emboss mud flaps with raised letters, numbers, or images. These engravings can later be painted to add to the aesthetic quality of the mud flap. The disadvantage is that these mud flaps require the construction of templates or molds, which can increase set up costs considerably. Also, the raised surfaces usually must be painted by hand, and the range of shapes and images that can be effectively used is narrow. Finally, the appearance of the letters, numbers, or images is limited to particular colors such as white and yellow.

This dilemma encouraged the advent of white surface mud flaps made from medium to high density polyethylene. The white surface accentuates all colors that are printed on it. Nevertheless, plastic mud flaps tend to break and tear much more easily than their rubber counterparts. Also, they tend to curl and bend more, and are less resistant to extreme weather conditions.

A person driving on the road is able to view other vehicles moving in the same direction for a longer period of time than static objects located along the same road, such as billboards, signs, or other displays. For example, the mud flaps located on the rear part of a vehicle can be viewed by other drivers or passengers, who are passing the vehicle with the mud flaps or driving behind the vehicle with mud flaps, for a sufficient amount of time to recognize, understand, and interpret an object or image on the mud flap. Depending on the driving conditions, a mud flap can be seen by an abundant number of people everyday.

In addition to mud flaps, there are a variety of other rubber based products that are limited in their aesthetic appearances, are subjected to hostile environments, and are frequently visible to large groups of people. Some examples include, but are not limited to, mats, tiles, bumpers, posts, and pallets.

Therefore, there is a need to reduce set up costs associated with manufacturing mud flaps that require the use of templates or molds. There is also a need to combine the advantages of the high resistance and durability of masticated rubber products with the attractiveness of white plastic surfaces. There is an even further need to improve and utilize the aesthetic qualities of rubber based products.

### SUMMARY OF THE INVENTION

The present invention relates to rubber based products, such as mud flaps, mats, tiles, bumpers, posts, and pallets, with printed images bonded to the products for aesthetic and advertisement purposes. The present invention also relates to methods of advertising using printed advertisements attached to rubber based products that are frequently visible to large numbers of potential consumers. The present invention also relates to rubber based products that are reinforced with steel components from tires. An embodiment of the present invention comprises a rubber blank and a portion of a tire incorporated into the rubber blank, wherein the portion of the tire contains steel.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a back view of a vehicle with mud flaps.

FIG. 1A is a perspective view of an advertisement sign.

FIG. 2 is a back view of a vehicle with a mud flap attached to a rear portion of the vehicle.

FIG. 3 is a perspective view of a mat or piece of tile with a printed image on the surface.

FIG. 4 is a perspective view of a advertisement structure.

### DETAILED DESCRIPTION

The embodiments described herein relate to methods and apparatus for advertising on rubber based products such as mud flaps, tiles, bumpers, posts, and pallets. Many of these rubber based products are formed from recycled rubber materials and include embossed letters, numbers, and images that can be used to identify a company's name, product, service, logo, or other advertising information. Due to the generally black background of the rubber material and the stencils or molds required to emboss the material, the range of colors and shapes that can be effectively used are limited. However, embodiments of the present invention overcome this problem with images printed on a media sheet that is attached to these rubber based products.

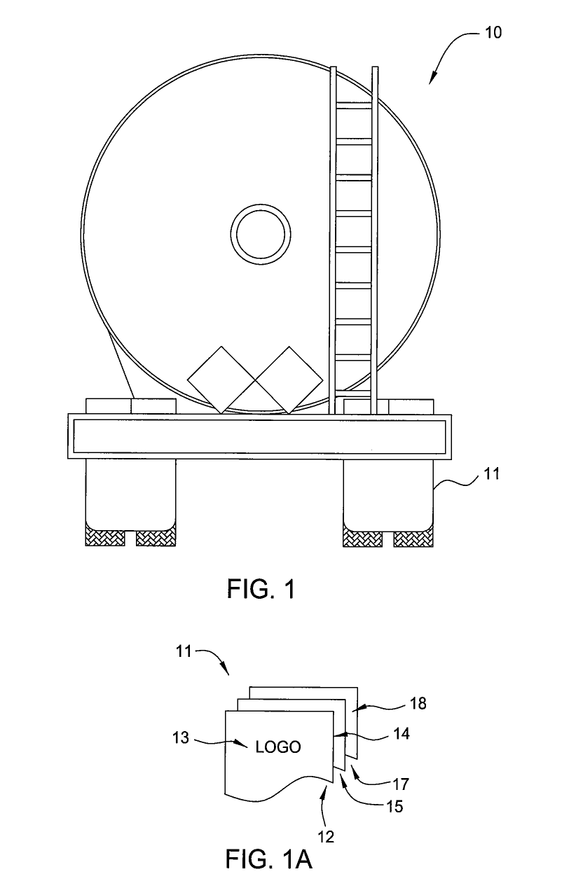

FIG. 1 illustrates the back part a vehicle 10. The vehicle has a pair of rubber based products attached to the rear portion of the vehicle, namely mud flaps 11. The mud flaps are visible to people viewing the back part of the vehicle. The view may be partially obstructed by the protective bar that is set at the rear end of some vehicles.

FIG. 1A shows one embodiment of the mud flap 11. The mud flap includes an image 13 printed on a media 12 that is bonded to a rubber blank 17. The rubber blank 17 can be formed from recycled rubber raw materials, such as tire scrap and uncured rubber. The raw material can also be reinforced with textile fabrics and other metallic components that come from recyclable tires. Normally, the raw material is processed into rubber blanks of varying lengths, sizes, and shapes that form the foundation of a rubber based product after the blank is heat treated. An example of heat treating a rubber blank includes placing the rubber blank into a heated press and pressing the blank so that it vulcanizes the rubber material.

As shown in FIG. 1A, after a rubber blank 17 is formed into the desired product, the appearance of the blank is enhanced by attaching an image 13 to a surface 18 of the blank. The image 13 is printed onto a media sheet 12. The media sheet 12 is preferably a sheet of polymer that may be formed from polyester, polyvinyl chloride, polyethylene, or some other thermoplastic material that can be used as a printing medium. In addition, the image 13 is printed on the media sheet 12 but can also be painted, drawn, or composed onto the sheet in a variety of other ways. Finally, the image 13 can be printed on the media sheet 12 by the use of screen printing, inkjet printing, laser printing, or other means of printing.

To attach the media sheet 12 to the rubber blank 17, the surface 18 of the blank is treated with a chemical mixture. The chemical mixture is used to break down the chemical bonds on the surface of the rubber, so that new chemical bonds can develop between the surface 18 and a later added bonding agent 15. The chemical mixture is applied to the surface 18 of the rubber blank 17 where the media sheet 12 is going to be attached. The mixture can be applied in several ways, such as sprayed or brushed onto the surface of the rubber, and the mixture can be applied manually or by an automated process. In one embodiment, the chemical mixture includes a halogen and chlorine and is produced in small batches.

Similarly, after the surface 18 of the rubber blank 17 is treated, a bonding agent 15 can be applied to the treated surface by the same or similar methods as the chemical mixture. In addition, the bonding agent 15 may also applied to a surface 14 of the media sheet 12 before it is attached to the rubber blank 17. The bonding agent 15 will also generate chemical bonds with the media sheet 12. After the bonding agent 15 is applied to one or both of the rubber blank 17 and the media sheet 12, the sheet can be attached to the rubber by placing the sheet on top of the treated surface 18 of the rubber, smoothing out any air pockets, and pressing the sheet and the blank together. In one embodiment, the bonding agent 15 is applied to the rubber blank 17 and the media sheet 12, and the blank and the sheet are attached together within a day after the surface 18 of the rubber is treated with the chemical mixture.

A method of advertising is disclosed. The method of advertising includes the following steps: printing an image on a sheet, treating a surface of a rubber blank with a chemical mixture, applying a bonding agent to the treated surface of the rubber blank and the sheet, pressing the sheet and the rubber blank together to form an advertisement, and displaying the advertisement. The advertisement is displayed in a manner, first, so that a large number of people will continuously see the advertisement, and second, so that the people will be able to identify, understand, and interpret the message that the advertisement is conveying. In an optional embodiment, the method further includes incorporating a portion of a tire into the rubber blank, wherein the portion of the tire has a steel component. The steel portion of the tire is used to reinforce the rubber blank, and thus the advertisement, to protect and prevent physical destruction and deterioration of the blank and advertisement.

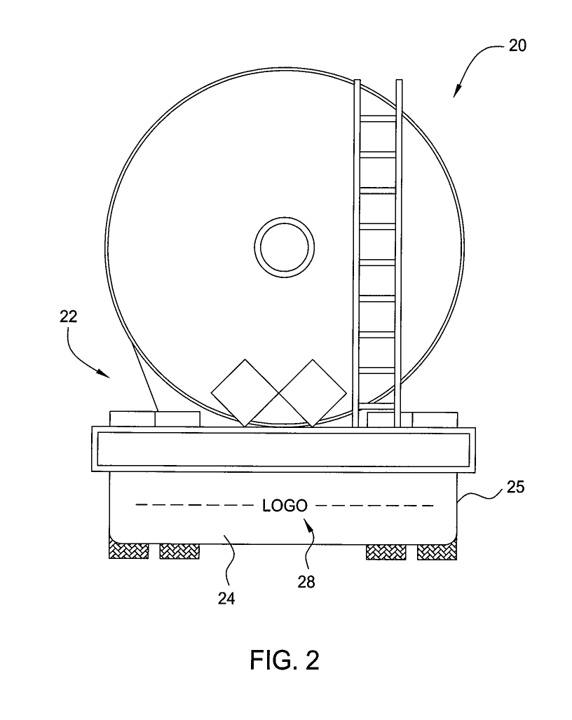

FIG. 2 shows an optional embodiment. The figure shows the back of a vehicle 20, a mud flap 25 attached to a rear portion 22 of the vehicle, and a advertisement 28 attached to a surface 24 of the mud flap. In this embodiment, the length of the mud flap 25 extends across most of the entire width of the vehicle's rear portion 22. However, in other embodiments, the mud flap 25 may include two or more mud flaps that may be attached to the rear portion of the vehicle, so that the combined mud flaps extend across the entire width of the rear portion. Finally, the mud flap 25 may be removably attached to the vehicle 20 so that mud flaps with other advertisements may be interchangeably displayed.

FIG. 2 shows another method of advertising. The method of advertising includes the following steps: selling advertisement space on a mud flap 25, attaching a printed advertisement 28 on a surface 24 of the mud flap, attaching the mud flap 25 on a rear portion 22 of a vehicle 20, and operating the vehicle with the printed advertisement displayed at the rear portion of the vehicle. There are many ways of selling advertisement space on the mud flap 25, such as renting advertising space on mud flaps or selling the mud flap with a product, service, or other advertisement printed on the mud flap. In addition, the following types of vehicles may be utilized with this method of advertising: passenger vehicles such as cars, trucks, and buses, construction vehicles such as dump trucks, cranes, and tractors, and other transportation vehicles such as trains, boats, and planes. Finally, there are also many ways of operating the vehicle 20, such as driving, towing, or parking the vehicle so that the advertisement 28 can be seen by large numbers of people.

The method of advertising further includes displaying the mud flap 25 substantially across the entire width of the rear portion 22 of the vehicle 20 and incorporating a portion of a tire into the mud flap, wherein the portion of the tire has a steel component. The steel portion of the tire is used to reinforce the mud flap, and thus the advertisement, to protect and prevent physical destruction and deterioration of the mud flap and the advertisement. The wire reinforcement will also avoid the sailing of the mud flap, making it stand vertical in spite of the wind forces generated by the movement of the vehicle.

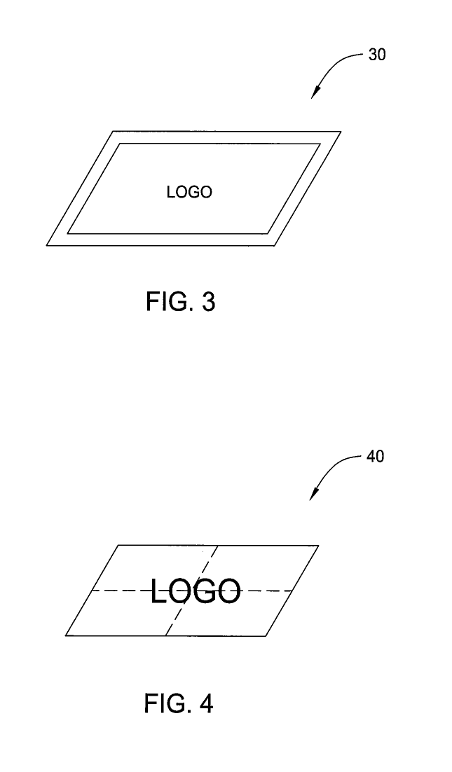

FIGS. 3 and 4 show alternative or optional embodiments. FIG. 3 shows a rubber based mat or piece of tile 30 with a printed image attached to the rubber in the same fashion as described in FIG. 1A. Individual pieces of tile may have a portion of an advertisement attached to them, so that they can be combined to form a complete advertisement as shown in FIG. 4. FIG. 4 shows a rubber based flooring 40 with a printed advertisement attached to the rubber in the same fashion as described in FIG. 1A. The softer rubber based flooring 40 may be used instead of a hard wood or other type of flooring for places such as gyms or factories, while at the same time being utilized as an advertising space. In addition, the rubber based flooring may actually be utilized as a door, wall, ceiling, or other structure that may take advantage of the numerous rubber based properties and the advertising capabilities. The tile or flooring can be formed as a cover over another structure or be formed into a structure itself. Finally, both of the rubber based mat or tile 30 and the rubber based flooring 40 may be layered with a protective coating (not shown) to protect the advertisement from wear and maintain its aesthetic appearance.

FIGS. 3 and 4 show an optional method of advertising. The method of advertising includes the following steps: selling advertisement space on a piece of tile formed from a rubber material, attaching a printed advertisement on a surface of the piece of tile, installing the piece of tile in a visible area with the printed advertisement displayed thereon. In this embodiment, the piece of tile can be used as a mat, some type of flooring material, a covering, or a structure itself. For example, the tile can be used on gym floors or factory floors that would benefit from the rubber base, which can provide a safer, softer surface or a better gripping surface, while at the same time displaying an advertisement to a large number of people.

In addition, the method of advertising includes treating the printed advertisement with a protective coating or layer, incorporating a portion of a tire into the piece of tile, wherein the portion of the tire has a steel component, and placing one or more of the pieces of tile together to form an advertisement structure. The advertisement structure can be treated with a coating to protect it from wear and maintain its aesthetic appearance. A single advertisement can be printed on individual pieces of tile or multiple pieces. The pieces of tile can be put together to form or cover a floor, a wall, a ceiling, or some other structure, all of which can be used to display the advertisement.

Embodiments of the present invention include rubber based products that are reinforced with portions of a tire that contain steel. Embodiments of present invention also include a method of reinforcing rubber based products with tire components that contain steel. Embodiments of the present invention further include a method of recycling tire components that are normally dumped into landfills or burned in incinerators, thereby saving valuable land space and reducing air pollution. Some examples of rubber based products include, but are not limited to, mud flaps for vehicles, mats such as floor mats, door mats, or vehicle mats, floor tile for gym and work out floors, factory floors, or building floors, bumpers for vehicles, pallets for storage or moving items, and posts such as street posts, vehicle or pedestrian barriers, or construction posts. These rubber based products are produced from natural or synthetic rubber, rubber scrap, textile friction, and tires.

The basic components of a tire include a rim, a bead wire, sidewalls, a steel belt, and a tread. The steel belt generally consists of woven steel fabrics. Other components of a tire may include textile friction, a tire floor, and a tire floor liner. The main steel components of the tire are the bead wire and the steel belt. Because the uncured rubber is extremely hard to separate from the steel bead wire and the steel belt, these components are normally discarded or burned when recycling a “green tire.”

A “green tire” is a tire that is considered defective for some reason and has not yet been cured or vulcanized. Green tires are usually fully assembled, but can be partially assembled, prior to being marked as defective or cured in a heating process. Green tires are a good source of raw materials for producing and reinforcing rubber based products.

In one embodiment, a tire is fully recycled into a reinforced rubber based product. In an optional embodiment, particular components of a tire can be combined with other raw materials to produce and reinforce rubber based products. In an optional or alternative embodiment, portions of particular components of a tire can be combined with other raw materials to produce and enhance the qualities of rubber based products.

In an alternative embodiment, a rubber blank is produced from recycled raw materials and has a section of a steel tire component pressed into the center of it. For example, the section and can be placed on top of the rubber blank at a desired location, and both of the pieces can be placed in a heated press and pressed together so that the section is incorporated into the rubber blank and the rubber is cured. The section is a longitudinal strip from a steel belt that is pressed into the center of the rubber blank so that the section is flush with a surface of the rubber blank. In addition, woven steel fabrics from the steel belt lie in a generally horizontal direction. If the rubber blank is bended, twisted, stretched, or ripped along the section, the steel fabrics will enhance the rubber blank's resistance to such movements. Therefore, the section reinforces the rubber blank and makes it stronger and more durable against external forces.

The section may be positioned in the rubber blank so that it is flush with any surface, corner, or edge of the blank, or so that it is completely disposed within the thickness of the blank. The section may also be raised so that it sits on the surface of the rubber blank. The section may also be placed in a position where the steel fabrics lie in a vertical direction, at an angle, perpendicular to the blank, or in multiple directions. More than one section may be used and positioned at various locations or stacked throughout the rubber blank. Numerous combinations of the above described features can be utilized to add to the rubber blank's resilience.

In an alternative embodiment, the rubber blank is reinforced with a steel bead wire from a tire. The steel bead wire is pressed into the center of the rubber blank. Similar to the section described above, the steel bead wire may be placed at numerous positions, locations, and directions within or on the rubber blank. Also, portions of a steel bead wire or multiple steel bead wires may be used to reinforce a rubber blank as needed. The wire reinforcement will also avoid the sailing of the rubber blank. For example, if the rubber based product is a mud flap positioned on a vehicle, the reinforcement will make help it stand vertical in spite of the wind forces generated by the movement of the vehicle.

In alternative embodiment, the rubber blank may be reinforced with combinations of a steel belt, a steel wire bead, and other traditional filler materials, such as textile cords, heavy duty wire, etc. In addition, the rubber blank may have a sheet of polymer, which contains a printed image, attached to it. Finally, the rubber blank may be formed into a mud flap, mat, tile, bumper, pallet, post, or other rubber based product.

As described in the foregoing, a procedure for reinforcing a rubber blank will be discussed. Consequently, a method for recycling tires also will be discussed. A method of reinforcing a rubber blank involves undressing a tire into components, masticating some of the components into a mixture, forming the mixture into a rubber blank, and incorporating the steel components from the tire into the rubber blank.

Undressing a tire into components involves separating the tire into pieces that can be used as recyclable raw materials. The process also involves removing the steel components of the tire so that they can be used as reinforcing materials. The components of a tire may vary but generally include a rim, steel bead wires, sidewalls, textile friction, a steel belt, a tire floor, a tire floor liner, and a tread. Stripping or tearing out the tire components can be done manually, automatically, or by a combination of both a manual and automated process. The use of solvents and cutting devices can be used to facilitate the separation process, particularly for the removal of the steel bead wires and steel belt.

Some of the tire components can be refined into small pieces or particles by a series of cutting and chopping machinery. Initial cutting of the raw material can be performed by large guillotines, if necessary, after which chopping units can be used to chew up the material into small particles. These small pieces or particles may be used to form rubber blanks and other rubber based products. Alternatively, these small pieces or particles can be mixed with other raw materials, such as a textile friction, prior to being converted into blanks and products. Fabric cords in the textile friction help increase the durability of the rubber.

Rubber blanks can be formed from the raw materials in a variety of ways. The material may be conveyed through a rolling mill to flatten it into sheets of varying thicknesses and lengths, after which the sheets may be cut into rubber blanks of desired shapes and sizes. These rubber blanks constitute the foundation of many rubber based products.

The steel bead wires and steel belt from a tire can be pressed into the rubber blanks to reinforce the blanks against external forces. One example includes, but is not limited to, a rubber blank is laid on a template and a section of a steel belt or bead wire is placed on top of the rubber blank. The template, rubber blank, and section are then forced together in a heating press that presses the section into the rubber blank and vulcanizes the rubber into the shape of the template. Multiple sections of a steel belt or bead wire can be placed at different locations on the rubber blank and in an array of positions, prior to being incorporated into the blank.

Additionally, multiple rubber blanks or sections of rubber blanks can be used to form a rubber based product. For example, two rubber blanks can be laid on a template, with a steel tire component placed on top of or between the rubber blanks, prior to being inserted into a heating press. In another example, a small piece a rubber blank can be placed on top of another larger rubber blank, along with a steel tire component, and pressed together to add rubber to a certain part of the final product. In a further example, a rubber blank can be formed with extensions or protrusions stemming from the rubber blank, and the rubber blank or the extensions may be reinforced with a steel tire component.

In an alternative embodiment, sections of a steel tire component can be encased or laminated with a rubber blank, other rubber material, or textile friction, wrapped with a shrink wrapping device, and placed in a heated compression device, such as an autoclave, to form a reinforced rubber based post or other similar products.

In an optional or alternative embodiment, a sheet of polymer can be attached to a rubber blank. A surface of the rubber blank is treated with a chemical mixture. The chemical mixture is spread or sprayed onto the surface of the rubber blank to loosen and fragment the chemical bonds along the surface of the rubber. The break up of these chemical bonds will enable the surface to create new chemical bonds with a later applied bonding agent. The chemical mixture may comprise of a halogen or a chlorine component and may be produced in small batches.

After the surface of the rubber blank is treated with the chemical mixture, a bonding agent is applied to the treated surface. The bonding agent may even be applied to the sheet of polymer. The sheet of polymer is then arranged on top of the treated rubber surface, with the bonding agent in between the two surfaces, and the sheet of polymer and rubber blank are pressed together. The bonding agent creates chemical bonds with the rubber blank and the polymer sheet. It is preferred that the sheet of polymer is attached to the rubber blank within a day after the surface is treated with the chemical mixture. The image may be printed on the sheet of polymer after it is attached to the rubber blank, but it optionally may be printed on the sheet of polymer before attachment. In addition to being printed, the image can be painted, stamped, drawn or placed on the sheet in a variety of other ways.

While the foregoing is directed to embodiments of the present invention, other and further embodiments of the invention may be devised without departing from the basic scope thereof, and the scope thereof is determined by the claims that follow.

1. An advertisement sign, comprising:
a rubber blank, having a surface of the rubber blank treated with a chemical mixture comprising a halogen;
a sheet of polymer;
a bonding agent, wherein the bonding agent is chemically bonded to the treated surface of the rubber blank and the sheet of polymer; and
an image printed on a surface of the sheet of polymer.

2. The sign in claim 1, wherein the rubber blank comprises at least one of a mud flap, a mat, a piece of tile, a bumper, a pallet, and a post.

3. The sign in claim 1, wherein the rubber blank comprises a portion of a tire.

4. The sign in claim 3, wherein the portion of the tire comprises steel.

5. The sign in claim 1, wherein the image represents at least one of a product and service.

6. A method of advertising, comprising:
printing an image on a sheet;
treating a surface of a rubber blank with a chemical mixture;
applying a bonding agent to the treated surface of the rubber blank and the sheet;
pressing the sheet and the rubber blank together to form an advertisement; and
displaying the advertisement.

7. The method of claim 6, wherein the chemical mixture comprises a halogen.

8. The method of claim 6, wherein the bonding agent is chemically bonded to the treated surface of the rubber blank and the sheet.

9. The method of claim 6, wherein the advertisement comprises at least one of a mud flap, a mat, a piece of tile, a bumper, a pallet, and a post.

10. The method of claim 6, further comprising incorporating a portion of a tire into the rubber blank.

11. The method of claim 10, wherein the portion of the tire comprises steel.

12. The method of claim 6, wherein the advertisement spans across an entire length of a rear portion of a vehicle.

13. The method of claim 6, wherein the advertisement represents at least one of a product and service.

14. A method of advertising, comprising:
selling advertisement space on a mud flap;
attaching a printed advertisement to the mud flap;
attaching the mud flap to a rear portion of a vehicle; and
operating the vehicle with the printed advertisement displayed at the rear portion of the vehicle.

15. The method of claim 14, further comprising displaying the mud flap substantially across the entire width of the rear portion of the vehicle.

16. The method of claim 14, further comprising displaying one or more of the mud flap substantially across the entire width of the rear portion of the vehicle.

17. The method of claim 14, wherein the printed advertisement represents at least one of a product and service.

18. The method of claim 14, further comprising incorporating a portion of a tire into the mud flap.

19. The method of claim 18, wherein the portion of the tire comprises steel.

20. A method of advertising, comprising:
selling advertisement space on a piece of tile comprising a rubber material
attaching a printed advertisement on a surface of the piece of tile; and
installing the piece of tile in a visible area with the printed advertisement displayed thereon.

21. The method of advertising in claim 20, further comprising treating the printed advertisement with a protective coating.

22. The method of claim 20, further comprising incorporating a portion of a tire into the piece of tile.

23. The method of claim 22, wherein the portion of the tire comprises steel.

24. The method of claim 20, further comprising placing one or more of the piece of tile together to form an advertisement structure.

25. The method of claim 20, wherein the printed advertisement represents at least one of a product and service.
